(19) United States
(12) Patent Application Publication
(10) Pub. No.: US 2007/0048706 A1
(43) Pub. Date: Mar. 1, 2007

(54) Psychometric assessment tool and method for interpreting human personality and human behavior

(76) Inventor: Ah Thau Tan, Kuala Lumpur (MY)

Correspondence Address: DONN K. HARMS;PATENT & TRADEMARK LAW CENTER, SUITE 100, 12702 VIA CORTINA, DEL MAR, CA, 92014, US

(21) Appl. No.: 11/484,981

(22) Filed: Jul. 11, 2006

(30) Foreign Application Priority Data
Aug. 26, 2005 (MY) PI 2005 4009

(51) Int. Cl. G09B 19/00

(52) U.S. Cl. 434/236

(57) ABSTRACT

An assessment tool that utilizes a psychometric test that can predict more accurately human personality by combining personality types derived from the 5 dimensions of a personality profile thereby providing a psychometric instrument, in the form of a 5-dimensional model organized into a symbol known as a “Spider Web”.

This invention relates to the field of personality assessment and in particular to a psychometric assessment tool and method for interpreting personality profile and human behavior.

### BACKGROUND OF THE INVENTION

Personality psychology is a branch of Behavioral Science that seeks to explain the uniqueness of patterns of human behavior in a more scientific manner through the use of research tools to study personality defined as the character of emotion, thought, and behavior patterns unique to a person.

This is particularly useful in both Human Resource Management and Organizational Performance Management and many different tests, assessments and tools have been developed in an attempt to accurately measure, assess, interpret and predict human personality and behavior designed to provide targeted insights in personality traits, characteristics, behavioral competencies, personal strengths and shortcomings, values; managing family, friends, bosses, colleagues and customers; identifying the quality of skills in leadership, motivation, communication, interpersonal relationship, time management, conflict management, planning and organizing, change management, problem solving and decision making; teambuilding, and to perform human resource functions such as personnel selection, job fit boss-subordinate fit, training and development, occupational interests, retrenchment, restructuring, and succession planning.

Popular among the assessment tools is the use of a psychometric test whereby the candidate is required to fill out a number of multi-choice questionnaires and/or self report statements with a large number of questions or self-report statements administered either by pen and paper or through a computer program via the internet or intranet. Based on the answers to the questions or self-report statements posed, a personality profile of the particular candidate can be drawn up.

This personality profile can then be compared with a standard or ideal profile purposely selected for a particular task or a predetermined function or categorize the candidate according to a Personality Type Indicator e.g. the well known Myers Briggs Type Indicator (MBTI). The MBTI slots human behavior into sixteen different personality types It measures people in four areas subdivided by two functions which are Extroversion-Introversion (E,I) Sensing-Intuition (S,N) Thinking-Feeling (T,F), and Judging-Perceiving (J,P) Consequently under the pairs of bipolar traits, human beings are classified into 16 personality types, namely ESTP, ESTJ, ISTJ, ISTP, ISFJ, ISFP, ESFP, ESFJ, INFJ, INFP, ENFP, ENFJ, INTJ, INTP, ENTP, and ENTJ.

Other well known assessment tools, for instance, the one developed by John Geiser's Personal Profile System, tends to classify human personality into four adjectival descriptors, (DISC), which are Dominance, Influence, Steadiness, and Conscientiousness, Whereas Lewis Goldberg Big 5 classify human personality into 5 clusters using adjective descriptors, (OCEAN) namely, Openness, Conscientiousness, Extroversion, Agreeableness and Neuroticism. Most of the prior art of psychometric testing use as a measure, the Human Trait, which is the smallest unit of human behavior that is found in all human personality, and Language as the communication tool to identify its characteristics and qualities.

Whilst Myer Briggs came out with 4 pairs of bipolar traits and group personality into 16 types to explain behavior, Personal Profile System and the Big 5 each separately use adjectival descriptors to explain human personality and behavior. They build their theory base on one theoretical construct, for example, Myers Brigg Type Indicator (MBTI) is based on the theoretical construct on Carl Jung Psychodynamic Theory; Personal Profile System (DISC) is constructed based on the Social Cognitive theory of William Marston and the Big Five Factors (OCEAN) is developed from the trait theories of McCrae, Costa and Lewis Goldberg. As a result the prediction of behavior is limited to one theory to explain human differences. For example MBTI is designed to predict normal human behavior and assume that human personality is constant and is not sensitive to environmental differences, while Personal Profile System DISC, do attempt to predict behavior in a favorable and unfavorable environment, their 4 adjective descriptors is not inclusive of all human traits. For example, they could not predict the dynamic/adaptive aspect of human behavior where the traits manifested are inconsistent across situation and over time. The Big Five Factors (OCEAN) is not inclusive of all human traits. Its taxonomy does not include traits like honesty, deceptiveness, conservativeness, conceit, and thrift MBTI, DISC and OCEAN merely describe human behavior but do not explain how and why human beings behave the way they do. Because of that, their approach is entirely nomothetic, and not idiographic.

A number of Patents have been granted which describes other methods for assessing personality characteristics, for example, U.S. Pat. No. 6,159,015 issued to Buffington, et. al, on Dec. 12, 2005 discloses a method of personality assessments utilizing sets of multiple-choice questions and word selections. The method involves administering separate profiling instruments that are then correlated and adjusted to be congruent. Whereas in U.S. Pat. No. 5,795,155 issued to Morrel-Samuels on Aug. 18, 1998, it involves a leadership trait assessment method wherein the respondent is asked to rank statements directed toward a characteristic of a respondent by manipulating movable objects. Rankings of the statements are then used to assess the respondent's leadership style. In the above methods, the respondents are required to in some way answer a set of questions that can then be used to determine certain characteristics and/or traits of the respondents.

Despite the existence of a variety of personality evaluation methods and tools, there is still a need for a system, method and testing instrument efficient and accurate enough to meet present day demands and requirements of Business and Industry especially in Human Resource Management.

It is the primary objective of the present invention to provide for a more comprehensive and a more accurate test of personality assessment by integrating the concepts and findings of the personality theories via psychodynamic, humanistic and social cognitive and trait theorists to predict human differences.

It is also an objective of the present invention to provide for a psychometric instrument to identify human differences and to classify human beings into different types in order to utilize them for Human Resource Management functions.

Another objective of the present invention is to provide a psychometric test for a user to perform an online self evaluation of his/her own personality traits and characteristics and thereafter to provide him/her with a tool to interpret it.

Yet another objective of the present invention is to provide a psychometric test that can be used and even modified by the user to perform specialized and customized personality self-analysis designed to accurately relate him/her to his/her associates.

A further objective of the invention is to provide for a quick, cheap, user friendly, and highly effective test of self personality assessment and transfer of know how using common sense psychology to interpret human differences

Yet a further objective of the invention is for the user to discover himself or herself and to develop his/her potential.

Yet another further objective is to help the user to discover the personality of others and to influence them to make things happen.

Yet still another further objective is to provide an assessment tool for human resource functions such as personnel selection, job fit, and succession planning, training and development and retrenchment.

These and other objectives and advantages of the present invention will no doubt become apparent to those skilled in the art after having read the following detailed description of the preferred embodiments which are described in the following specification and illustrated in the figures of the drawings.

### SUMMARY OF THE INVENTION

The present invention is an assessment tool that utilize a psychometric test that can predict more accurately human personality by combining 10 personality types derived from the 5 dimensions of a personality profile thereby providing a psychometric instrument, in the form of a 5-dimensional model organized into a symbol known as a Spider Web to better interpret the individual personality profile.

The present invention is a psychometric test that utilizes a self report statement bank utilizing preferably, the Likert Scale to obtain a more accurate response of the individual personality assessment.

The present invention is a psychometric test that may also allow the alignment of two or more personality profiles such that a compatibility analysis of the two or more may be obtained.

The present invention is a psychometric test and assessment tool for understanding personality developed from the integration of personality theories incorporating with the needs and deprivation theories based on the following premises that state that:

1. Human behavior is motivated by needs satisfaction and deprivation

2. Human personality lies in the continuum of relatively static and dynamic

3. Human behavior lies in the continuum of normal and abnormal

4. Human personality is unique, no two persons are alike

5. Human personality is not constant. It may vary with the experiences in the environment

6. Human personality is developed from the genes and past experiences from the environment

7. Future experiences continually shapes a person's personality

The objective of the present invention is to recognize patterns of behavior of different personality types. The present invention is an assessment tool that explains how we humans think, feel and do. The present invention posits that thinking and feeling are our genetic traits and determines our IQ and EQ. What we do are learned traits. The present invention classifies human traits based on Needs and Deprivation Theories. The system's personality profile is made up of five dimensions, namely:

1. Self-Actualizing Self—the need for growth, achievement, progress, fulfillment, self-development and to find meanings in life

2. Egocentric Self—the need for power, image and control

3. Sociocentric Self—the need for love, care, companionship and affiliation

4. Security Self—The need for safety, order, system, structure and protection

5. Manipulative Self—The need to change and adapt for survival and growth

From the high and low of the five dimensions the assessment tool classifies human beings into ten dimensional personality types as follows:

1. Self-Actualizing Dimension—Normal Type Vs Neurotic Type

2. Egocentric Dimension—Aggressive Type Vs Submissive Type

3. Sociocentric Dimension—Sociable Type Vs Asocial Type

4. Security Dimension—Pragmatic Type Vs Adventurous Type

5. Manipulative Dimension—Static Type Vs Dynamic Type

Human personality is made up of five parts via high, average and low for the five dimensions above. The present invention assigns abbreviation for the ten types of personality as shown below:

1. Normal (HSA)

2. Neurotic (LSA)

3. Aggressive (HE)

4. Submissive (LE)

5. Sociable (HS0)

6. Asocial (LSO)

7. Pragmatic (HSE)

8. Adventurous (LSE)

9. Static (LM)

10. Dynamic (HM)

The average personality types in between are as follows:

1. ESA

2. EE

3. ESO

4. ESE

5. EM

The present assessment tool develops a self report statements Bank using the Likert Scale to identify and classify human beings into the ten dimensional personality types. It then organizes the five dimensions of personality types into a symbol known as (and resembling) a spider web, depicting the relative strength of the high, average and low of the five dimensions.

The present assessment tool identifies the formula of a personality profile by combining the abbreviations of the high average and low of the five dimensions from the spider web. Each dimensional personality type consists of a list of absolute personality types as stated below:

Normal Type (SA)—e.g. Reasonable, Result orientated, Hardworking

Neurotic Type (LSA)—e.g. Anxious, Depressed, Stressful

Aggressive Type (E)—e.g. Dominant, forceful, Demanding

Submissive Type (LE)—e.g. Accommodating, Gentle, Humble

Sociable Type (SO)—e.g. Caring, Friendly, Supportive.

Asocial Type (LSO)—e.g. Aloof. Individualistic, Impersonal

Pragmatic Type (SE)—e.g. Practical, Rule Orientated, Systematic

Adventurous Type (LSE)—e.g. Freedom, Impulsive, Spontaneous

Dynamic Type (HM)—e.g. Strategic, Complicated, Adaptable

Static Type (LM)—e.g.—Blunt, Naïve, Open

With the average personality types in between as abovementioned

The present assessment tool combines the abbreviation of the 5 dimensional personality in the form of a formula to recognize patterns of behavior to interpret human differences. The system's Personality Profile can also be identified by converting a descriptive narrative of an individual in a specific or particular situation and convert them into a formula to describe and interpret patterns of behavior.

The present invention can also use the formula derived from the spider web to identify the following:
Traits and Characteristics, Personal Strengths and Improvement Needs, Behavioral Competencies, Self Management, Responses to Change, Managing Time, Managing Stress, Managing Conflict, Planning and Organizing, Motivation, Communication and Interactive Styles, Interpersonal, Relationships, Managing feelings, Delegation, Coaching and Counseling, Leadership, Managing people, process, data and operations, Team building, Job preferences and others.

### BRIEF DESCRIPTION OF THE DRAWINGS

FIG. 1 shows a Flow chart to identify/draw a person's personality profile in accordance to the present invention.

FIG. 2 shows a Spider Web Diagram in accordance with the present invention.

FIG. 3 shows a chart illustrating Job Position Personality Profile Matrix in accordance with the present invention.

FIG. 4 is a table showing the different personality types and their traits in accordance to the present invention.

FIG. 5 is a table showing the different personality types and their characteristics in accordance to the present invention.

FIG. 6 is a table showing different personality types and their training needs in accordance to the present invention.

FIG. 7 shows a series of Diagrams illustrating Personality Profile Compatibility Analysis in accordance with the present invention.

FIG. 8 shows software system architecture of the present invention.

FIG. 9 shows the System Process—Flow of the present invention when it is web-based.

### DETAILED DESCRIPTION OF A PREFERRED EMBODIMENT

The present invention identifies and organizes the five dimensions of personality profile into a spider web from the user input and uses the spider web as a tool to identify, traits and characteristics. The traits and characteristics are then be related to leadership, time management, change management, conflict management, interpersonal relationship and others. The traits and characteristics identified from the spider web can also be used as a source of information for personnel selection, job fit, succession planning and other human resource functions.

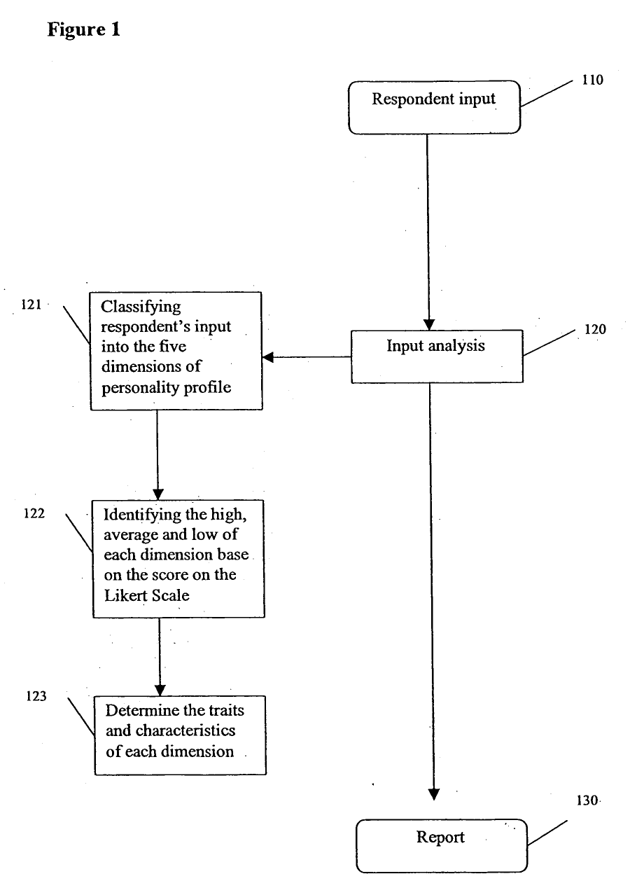

Referring to FIG. 1, the flow chart describes the process of identifying and deriving the personality profile of the user in accordance with the present invention. First the respondent/user will be given a hard and/or soft copy displaying a number of statements drawn from a Self Report Statement Bank, preferably above 25 rated on the likert Scale from 7-1. Step (110), a respondent input, required the respondent to mark the score on the scale for all the statements. Score of 7 means very much like the user and score of 1 means not like the user. After the respondent input (110), the scoring sheet is analyzed by the facilitator Step (120), an input analysis.

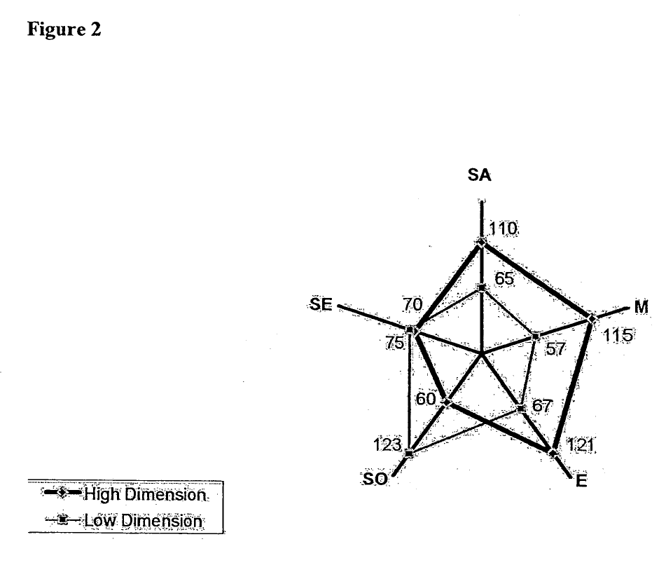

The facilitator/assessor begins by analyzing each statement in the respondent input (110) to identify the sociocentric, egocentric, security, self-actualizing and manipulative dimensions of the personality profile as explained in the flow chart step (121) classifying statements into each dimension. The next step (122) tallying the score of each dimension, required the facilitator/assessor to record the scoring of each statement under each of the five dimensions. The total score of all the statements under the cluster of each dimension determines the high, average and low of the ten personality type via normal and neurotic, sociable and asocial, pragmatic and adventurous, dynamic and static, aggressive and submissive. The facilitator then determines the traits, characteristics or behavioral competencies of each personality type as explained in step (123) A person's personality is made of five dimensions via the high, average and low of the personality type. The five dimensions of the personality profile is organized into a diagram known as the spider web as shown in FIG. 2.

The spider web comprises of 2 types of lines, with 1. The bold lines representing the five dimensions SA, SE, SO, M, E converging into point in the middle and 2. The thin lines joining the points that are plotted on the bold lines indicating the different dimensions to form the web. These thin lines may be in a plurality of sets. Each different set may be differently color coded with e.g. blue line indicating the high dimension and red line indication the low dimension.

With reference to the spider web in FIG. 2, the high dimensions are identified when the scoring on the blue line exceeds the scoring on the red line by a reasonably wide gap, preferably more than 20 points; determined by the scoring of on high and low of each dimension of the Likert scale. In this case three, high dimensions (HSA, HM and HSO) are identified. When the scoring on the red line exceeds the scoring of the blue line by a reasonably wide gap, preferably more than 20 points of the high and low of each dimension on the Likert Scale, it reflects the low dimension of the personality, in the above spider web, one dimension is identified as low (LSO). The average dimension is identified when the there is a reasonably narrow gap determined by the scoring on the Likert scale preferably less than 20 points, in this case one dimension is identified as average (EE). The above spider web identify the user personality as (HSA), dynamic type (HM), Aggressive Type (HE), Asocial Type (LSO) and in between neither Pragmatic nor Adventurous type (ESE).

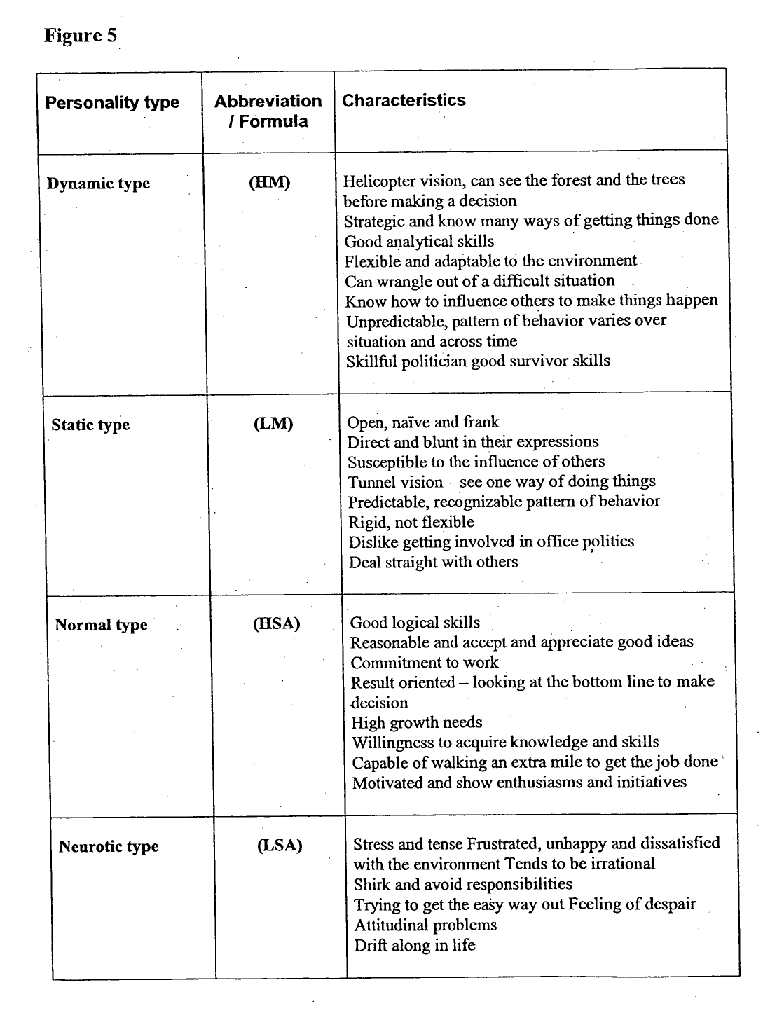

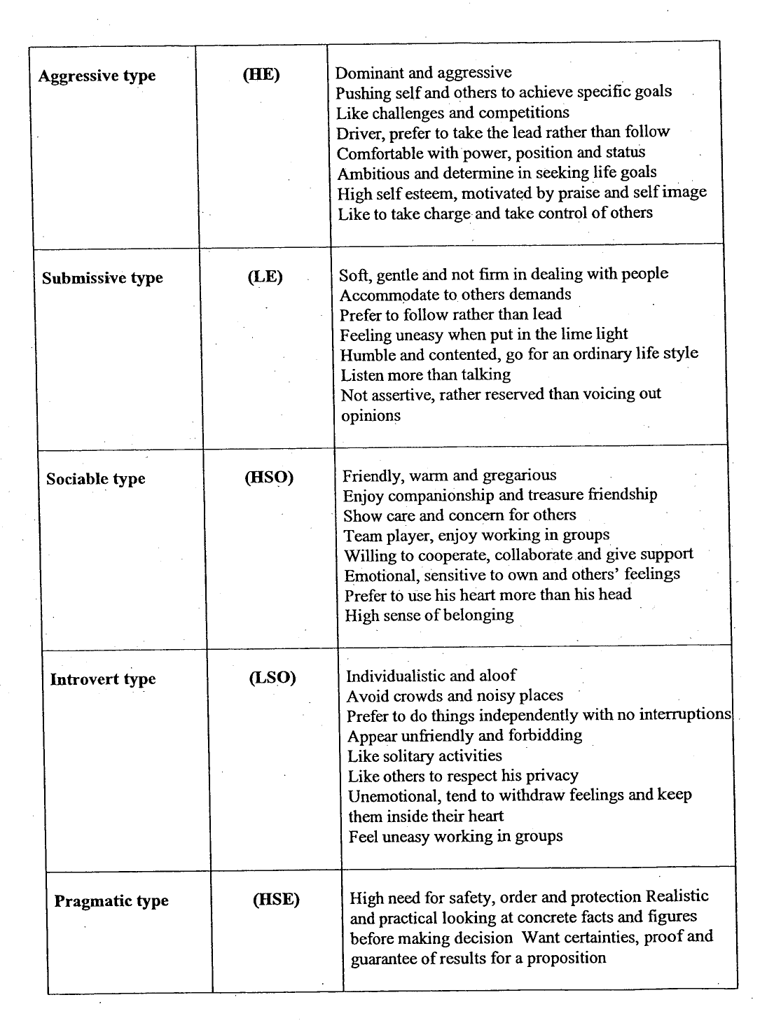

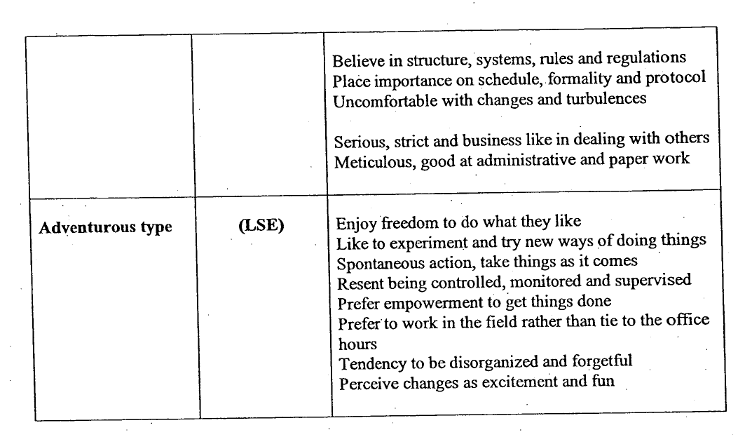

The final step is to write a report step (130) by identifying the traits and characteristics or behavioral competencies identified from the interpretation of the spider web. A specific example of a report (130) for leadership on the user from the above spider web (FIG. 2) with reference to FIG. 5 is the user has a helicopter vision of the scenario of the environment (HM) The user can see the forest and the trees and is strategic and know many ways of getting things done. (HM) He/she set high expectations and pushes himself/herself others (HE) to make things happen. (HSA) The user take pride and wants to be recognized for his/her achievement. (HE) The user works very hard and do not mind walking the extra mile to get things done (HSA). There is a tendency for the user to use an adaptive leadership style, a situation leader who uses different leadership styles in accordance with the people and the situation. (HM). The user prefers to work out things on his/her own (LSO) and would prefer to maintain a close door policy for his/her follower for consultation (LSO). The user is not fussy when it comes to dealings with facts and figures and would be able to make decision base on moderately sufficient information. (ESE). He/she take calculated moderate risk in dealings with others (HM+ESE). The user is likely to focus on his/her power bases (HE) to get to get the results. (HSA). The user would appreciate good performers and give them the credit they deserved. He/she would go after the marginal performers and pressurize them to get results. (HM+HSA)

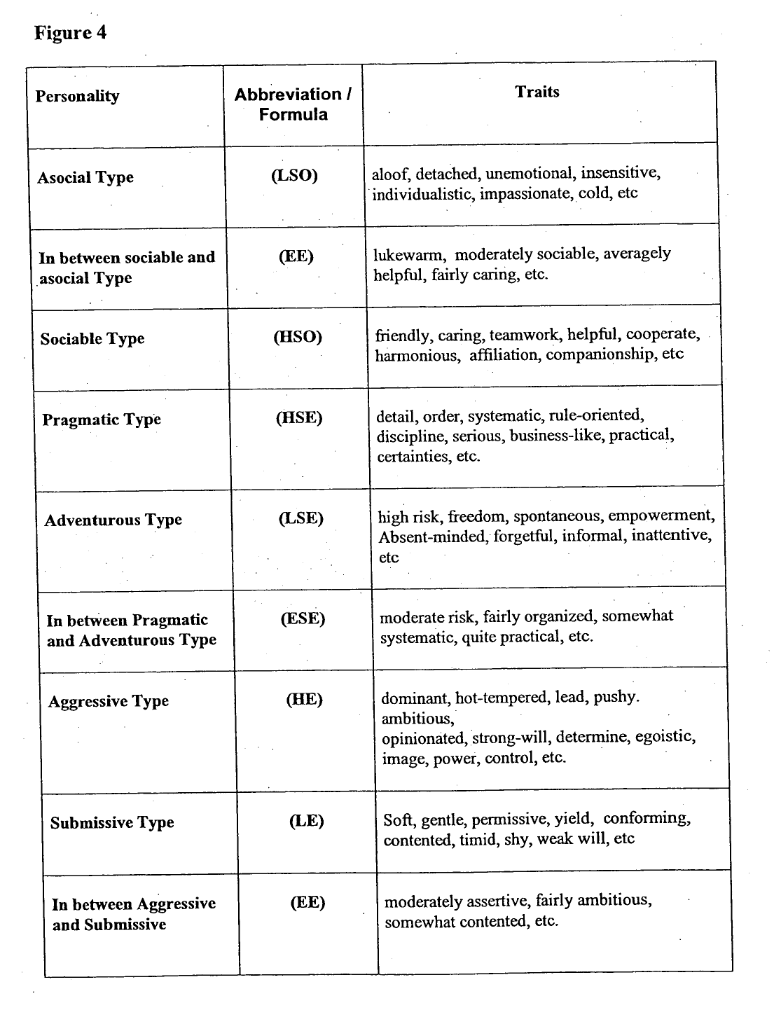

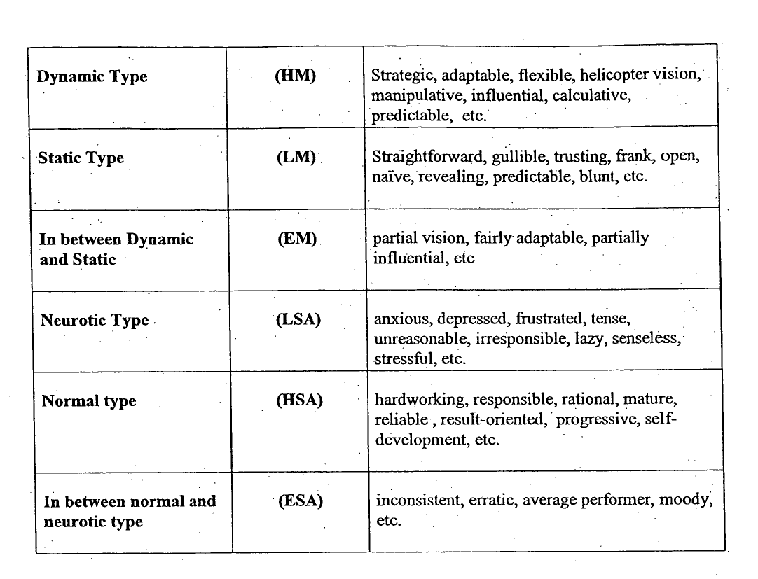

The traits and characteristics of the user identified in FIGS. 4 & 5 are as follow:
HSA—Responsible, hardworking and result-oriented, appreciative and fair, reward others for good work, willing to work hard and late at night, etc.
HE—Set high expectations, pushes others for results, determines to achieve what he/she starts, prefers to lead rather than to follow, etc.
HM—A visionary who has a bird eye view of the scenario of the environment, adaptable and flexible in his/her dealings, strategic and know many ways of making things happen, etc.
LSO—Individualistic and like to work independently on his/her own, Like to do solitary activities, avoid social interactions, unemotional and insensitive to others feelings.
ESE—Moderate in developing plans, average organizing skills, fairly systematic, not overly concern over detail, etc.

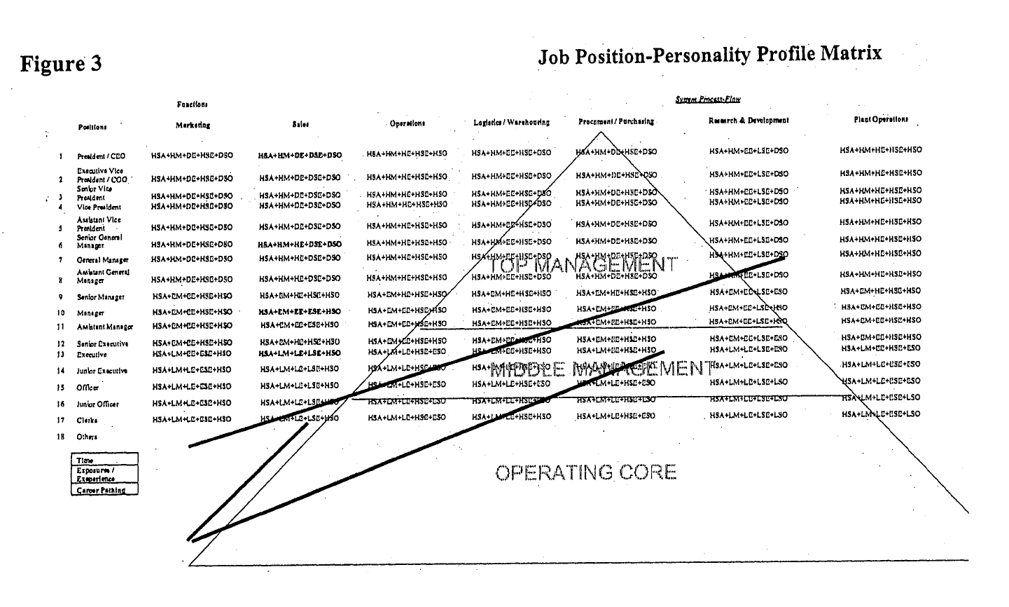

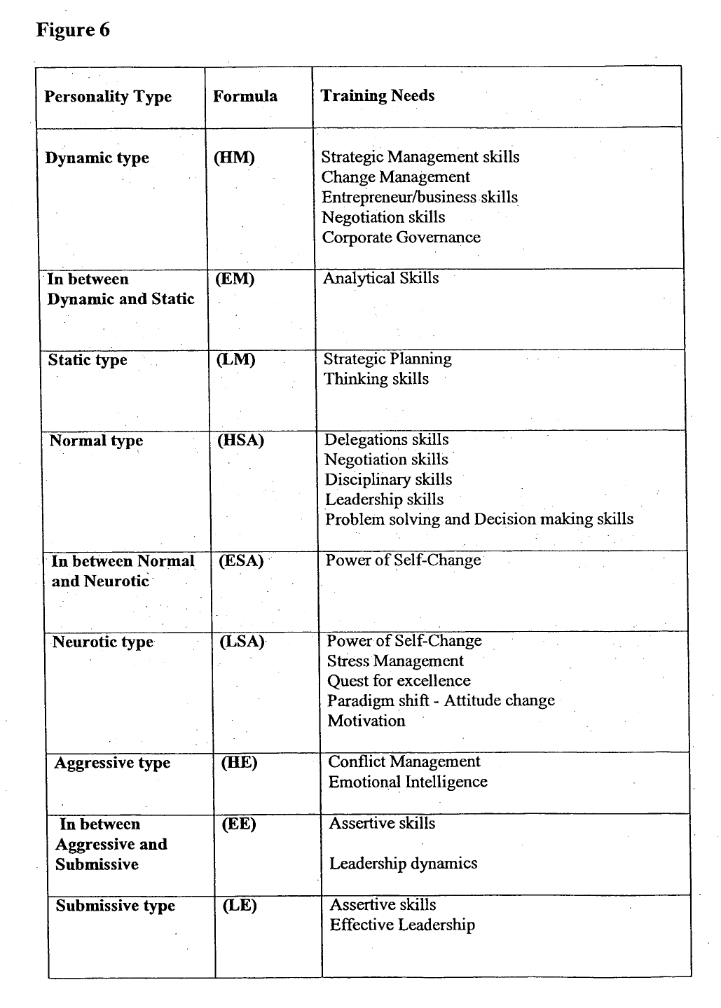

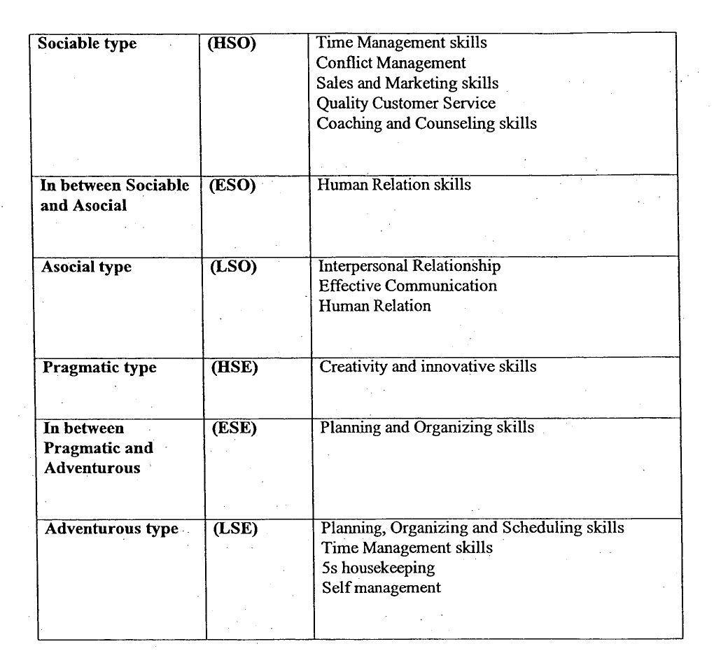

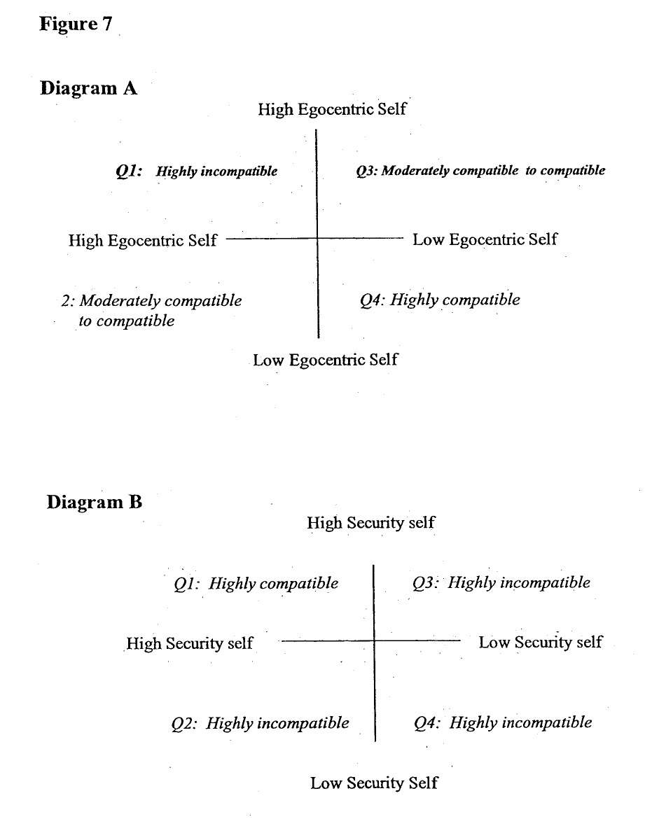

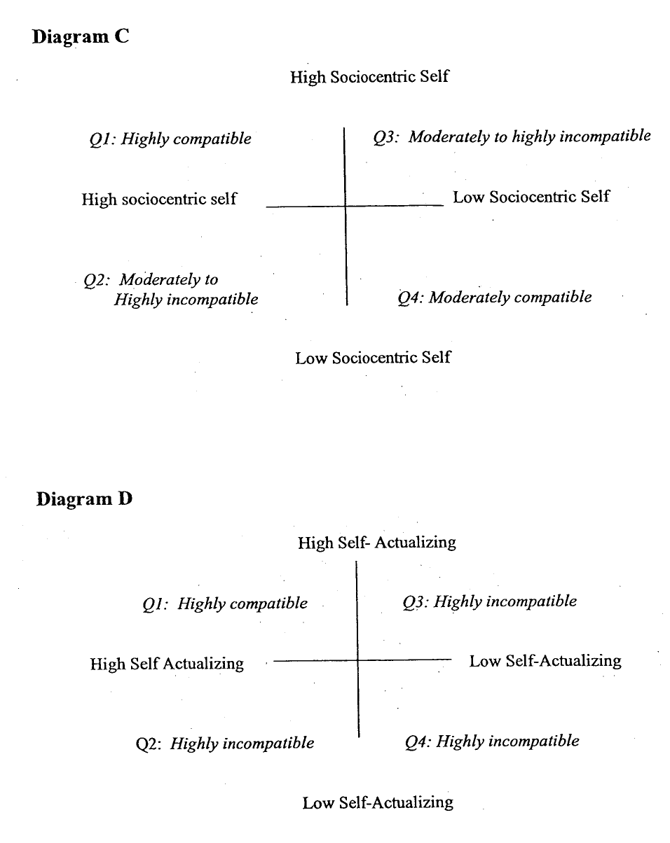

The report (130) base on different shapes of the spider web (FIG. 2) can also be used to interpret for conflict management, change management, interactive style, interpersonal relationship, time management and others soft skills by referring to FIG. 1, FIG. 2, FIG. 4 & FIG. 5. The present invention can also be used for human resource functions such as personnel selection (FIG. 1 to FIG. 5), job fit (FIG. 1 to FIG. 5), succession planning FIG. 1-FIG. 5), training and development (FIG. 1-FIG. 6), Boss-subordinate fit (FIG. 1 FIG. 7) and others.

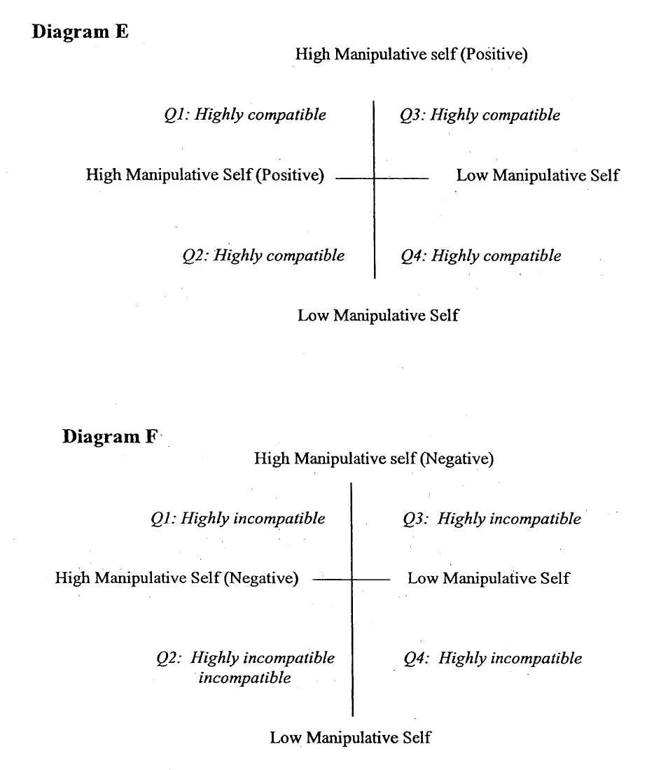

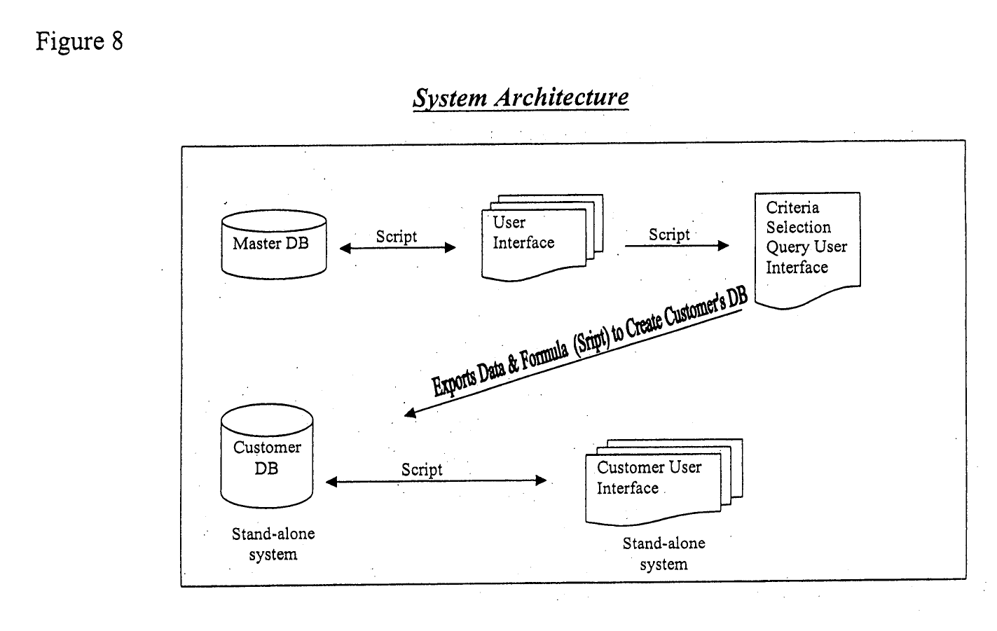

FIG. 8 shows the software system architecture of the present invention when it is web based.

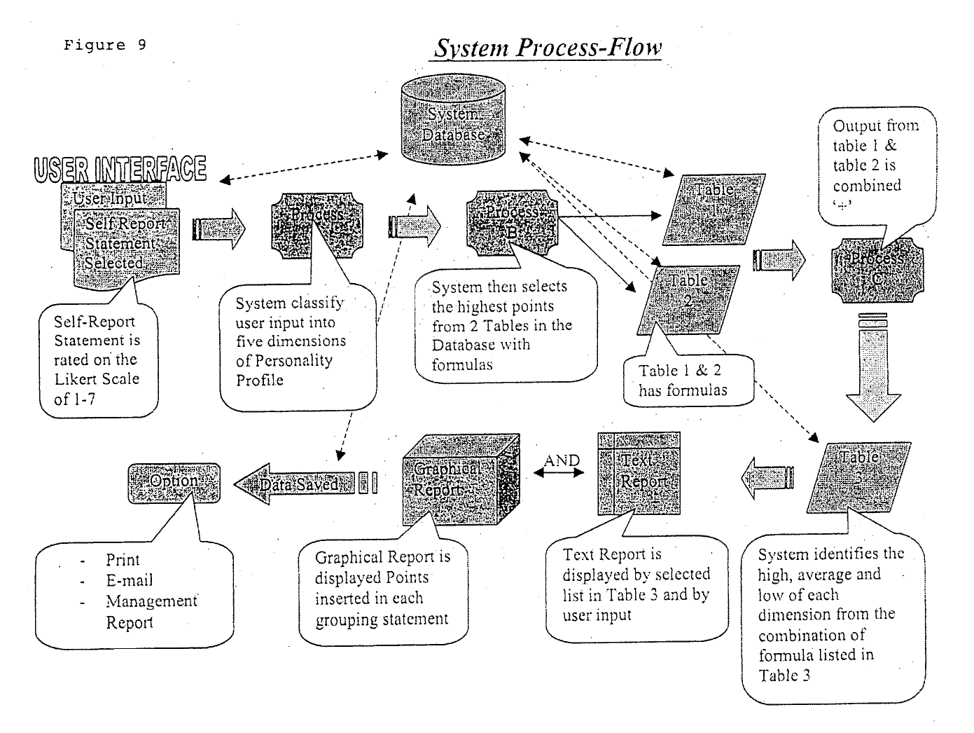

FIG. 9 shows the System Process—Flow of the present invention when it is web-based.

1. A method for identifying human personality for the purpose of Human Resource Management by utilizing an assessment tool and psychometric test comprising of the steps of:
a) compiling a Respondent Input (110) from responses to a plurality of Self Report Statements given to the respondent
b) Analyzing the Respondent Input (110) and classifying (121) the Self Report Statements into the Five Dimensions of Personality Profile, namely Self-Actualizing self, Egocentric Self, Sociocentric Self, Security Self and Manipulative Self.
Identify the ten personality types and the in between base on the scoring of the respondent on the Likert Scale of each dimension
c) Organizing the five dimensions of the respondent personality profile into a symbol known as the “Spider Web” (FIG. 2)
d) Identify (122) the high, average and low of the five dimensional personality profile
e) Abbreviating the high, low and average of the five dimensions and combine them into a formula
f) Determining (123) the traits and characteristics of each dimension base on the personality formula of the five dimensional Personality Profile
g) Writing a report (130) of the respondent Personality Profile base on the traits and characteristics identified from the high, average and low of each dimension and the interrelationship between each dimension of the “Spider Web”. (FIG. 2) for a specific purpose

2. A method for identifying human personality for the purpose of Human Resource Management as claimed in claim 1 wherein the report is for the specific purpose of personnel selection

3. A method for identifying human personality for the purpose of Human Resource Management as claimed in claim 1 wherein the report is for the specific purpose of job fit

4. A method for identifying human personality for the purpose of Human Resource Management as claimed in claim 1 wherein the report is for the specific purpose of training and development

5. A method for identifying human personality for the purpose of Human Resource Management as claimed in claim 1 wherein the report is for the specific purpose of boss and subordinate fit

6. A method for identifying human personality for the purpose of Human Resource Management as claimed in claim 1 wherein the report is for the specific purpose of succession planning

7. A method for identifying human personality for the purpose of Human Resource Management as claimed in claim 1 wherein the report is for the specific purpose of training and development

8. A method for identifying human personality for the purpose of Human Resource Management as claimed in claim 1 wherein the symbol of the “Spider Web” (FIG. 2) comprises of a plurality of sets of lines to cater for comparative analysis of two or more personalities

9. A method for identifying human personality for the purpose of Human Resource Management as claimed in claim 1 wherein the user can perform self analysis online using a computer

10. A psychometric assessment tool for identifying human personality by utilizing a psychometric test comprising steps of:
a) Compiling a Respondent Input (110) from responses to a plurality of Self Report Statements given to the respondent
b) Analyzing the Respondent Input (110) and classifying (121) the Self Report Statements into the Five Dimensions of Personality Profle, namely Self-Actualizing self, Egocentric Self, Sociocentric Self, Security Self and Manipulative Self.
Identify the ten personality types and the in between base on the scoring of the respondent on the Likert Scale of each dimension
c) Organizing the five dimensions of the respondent personality profile into a symbol known as the “Spider Web” (FIG. 2)
d) Identifying (122) the high, average and low of the five dimensional personality profile
e) Abbreviating the high, low and average of the five dimensions and combine them into a formula
f) Determining (123) the traits and characteristics of each dimension base on the personality formula of the five dimensional Personality Profile
g) Writing a report (130) of the respondent Personality Profile base on the traits and characteristics identified from the high, average and low of each dimension and the interrelationship between each dimension of the “Spider Web”. (FIG. 2) for a specific purpose in Human Resource Management.

11. A psychometric assessment tool for interpreting human personality comprising of psychometric instrument in the form of a symbol known as a “spider web” (FIG. 2) drawn from the five dimensions of respondent personality profile namely Self-Actualizing Self, Egocentric Self, Sociocentric Self, Security Self and Manipulative Self constructed by using the Input Analysis (120) derived from the Respondent Input (110) of responses from a plurality of Self Report Statements, so that by interpreting the shape of the spider web firstly analyzing the Input Analysis (120) and then by classifying (121) the self report statements and identifying (122) the high, average and low of the five dimension, is able to analyze; to determine (123) and to write a report (124) of the respondent personality profile for a specific purpose in Human Resource Management.

12. A system of interpreting human personality by utilizing the Five Dimensions of Personality Profile, namely Self-Actualizing Self, Egocentric Self, Sociocentric Self, Security Self and Manipulative Self derived from classifying (121) and organizing the said dimensions based on Input Analysis (120) on the Respondent Input (110) to the Self Report Statements by Identifying (122) the high, average and low of the five dimensional personality profile based on the ten personality types and the in between base on the scoring of the respondent on the Likert Scale of each dimension to construct a symbol known as a spider web and by determining (123) the traits and characteristics of each dimension base on the personality formula of the five dimensional Personality Profile resulting in writing a report (130) of the respondent personality profile for a specific purpose in Human Resource Management
